(19) United States
(12) Patent Application Publication
(10) Pub. No.: US 2012/0112633 A1
(43) Pub. Date: May 10, 2012

(54) System and Method For A Light Bulb Fixture with Sensor Switch and Its Operation and Method for operating the same

(76) Inventor: Jasopin Lee, Cupertino, CA (US)

(21) Appl. No.: 12/816,502

(22) Filed: Nov. 10, 2010

(51) Int. Cl. H01K 1/62; H05B 37/02

(52) U.S. Cl. 315/32; 315/149; 315/362

(57) ABSTRACT

A system and method of light bulb and fixture comprising an occupancy sensor, a light meter, and an on/off circuit switch is used to manage the lighting use base on the sensing the presence of people and area lighting condition. The occupancy sensor, light meter, an on-off circuit switch, and a regulator are incorporated into the light bulb or fixture for easy replacement and no need of re-wiring or major fixture change.

### CROSS-REFERENCE TO RELATED APPLICATIONS

| | | | |
|---|---|---|---|
| U.S. Pat. No. 5,662,441 | September 1997 | Haslam et al. | 362/276 |
| U.S. Pat. No. 6,151,529 A | November 2000 | Batko | 700/28 |
| U.S. Pat. No. RE37,135 E | April 2001 | Elwell | 315/154 |
| U.S. Pat. No. 6,566,882 B2 | May 2003 | Baldwin et al. | 324/418 |
| U.S. Pat. No. 6,583,573 B2 | June 2003 | Bierman | 315/419 |
| U.S. Pat. No. 6,798,341 B1 | September 2004 | Eckel et al. | 340/521 |
| U.S. Pat. No. 6,909,239 B2 | June 2005 | Gauna | 315/134 |
| U.S. Pat. No. 6,956,493 B1 | October 2005 | Youngblood | 340/693.9 |
| U.S. Pat. No. 7,005,802 B2 | February 2006 | Myron et al. | 315/56 |
| U.S. Pat. No. 2006/0181416 A1 | August 2006 | Chen | 340/545.2 |
| U.S. Pat. No. 7,122,976 B1 | October 2006 | Null et al. | 315/362 |
| U.S. Pat. No. 7,164,238 B2 | January 2007 | Kazanov et al. | 315/209 |
| U.S. Pat. No. 7,175,315 B2 | February 2007 | Eaton | 362/276 |
| U.S. Pat. No. 7,190,126 B1 | March 2007 | Paton | 315/308 |
| U.S. Pat. No. 7,327,254 B2 | February 2008 | Chen | 340/545.2 |
| U.S. Pat. No. 7,405,524 B2 | July 2008 | Null et al. | 315/308 |
| U.S. Pat. No. 7,585,087 B2 | September 2009 | Gagne et al | 362/221 |
| U.S. Pat. No. 7,626,339 B2 | December 2009 | Paton | 315/155 |
| U.S. Pat. No. 2009/0262189 A1 | October 2009 | Marman | 348/143 |
| U.S. Pat. No. 2010/0026194 A1 | February 2010 | Paton | 315/152 |
| U.S. Pat. No. 7,683,301 B2 | March 2010 | Papamichael et al. | 250/205 |
| U.S. Pat. No. 2010/0096993 A1 | April 2010 | Ashdown et al. | 315/113 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Light source power conservation requires a smart electronic control scheme to manage its power consumption. An automatic scheme will enable users to manage their use of electricity and potential energy savings easily, especially for high power rating lights. An interior light management system with automatic occupancy sensor with light metering and current switching built into the light bulb and fixture having the above mentioned characteristics is proposed. Users could easily replace a regular light bulb with this sensor enabled light bulb or fixture in certain low traffic areas, warehouses, or large meeting halls where regular bright lighting is not required all the time. This reduces the illumination energy used and manages the lighting automatically depending on demand without having to re-wire or add switches. Furthermore, a set percentage of light bulbs could be replaced with these sensor enabled light bulbs to maintain a desired lighting condition by controlling the number of fixed light bulbs deployed.

Faster acting light fixtures with motion sensors built in are commercially available today, but they do not have other characteristics that are needed for the applications intended for the proposed sensor enabled light bulb invention. The commercially available light fixtures are used for evening security purposes and for exterior use. However, they are not meant for managing interior lighting or for saving energy, nor are they available for said purposes. There is a new patent for LED lights with an integrated sensor, but they do have the characteristics and functions that reduce electricity used by traditional or high power consumption light bulbs.

There are many different types of devices commercially available today for sensing moving objects. The devices of primary interest here are those that can measure the presence of people at a given location and, at the same time, operate a switch indicating that the desired lighting condition has been reached and/or exceeded a pre-set condition.

### BRIEF SUMMARY OF THE INVENTION

A system and method for a light bulb and (interior) fixture with a sensor integrated into said light bulb and fixture hardware. The light bulb has an occupancy sensor with light metering with a convex or sphere shape cover fitted at the end or middle of the light bulb to facilitate the measurement of the presence of people or a moving object in a given area. The light fixture has an occupancy sensor and light meter with a convex or sphere shape cover fitted at the side or middle of the light fixture positioned towards the area of lighting. The occupancy sensor, light meter, an on-off switch, and a regulator (if needed) are incorporated into the hardware of the light bulb or fixture itself, instead of in another separated unit for easy light bulb replacement and there is no need of re-wiring or major fixture change. The occupancy sensor can be made with infrared, or ultrasonic, or microwave, or laser, or image, or sound sensing, or microwave technology and it will serve the purpose to signal a current cut-off switch. Thus the light bulbs is switched off when there is no human interaction in a given location after a set period of time, and switched on when there is a human presence. A second sensor, which measures the natural lighting and reflected light conditions for switching the bulb on and off, is also incorporated into the hardware.

The occupancy sensor and control circuitry housing can be fitted into the end or middle of the light bulb hardware and form a decorative shape on the light bulb assembly. Furthermore, the occupancy sensor light bulb can be separated into a sensor module and light bulb connecting configuration for re-using the sensor module. The sensor unit would also be easy to detach and attach to the light bulb for replacement and assembly too.

### BRIEF DESCRIPTION OF THE DRAWING

FIG. 1 shows a fluorescent light bulb with an integrated sensor on one side.

FIG. 1a shows three different fluorescent light bulb connectors.

FIG. 2 shows a fluorescent light bulb with an external occupancy sensor and light meter on the side.

FIG. 2a shows a fluorescent light bulb with an external occupancy sensor and light meter plugged in.

FIG. 3 shows a circular light bulb with an integrated sensor and light meter in the middle.

FIG. 4 shows a light bulb with an integrated sensor and light meter on top of a light bulb.

FIG. 5 shows a metal halide light bulb with a detached occupancy sensor and light meter.

FIG. 5a shows a metal halide light bulb with a detached sensor.

FIG. 6 shows a light bulb with integrated sensor.

FIG. 7 shows a light fixture with an integrated sensor on one side.

FIG. 8 shows a light fixture with an integrated sensor.

FIG. 9 shows commercial light fixtures with sensors.

FIG. 10 shows commercial high power metal halide light fixtures with sensors.

### DETAIL DESCRIPTION OF THE INVENTION

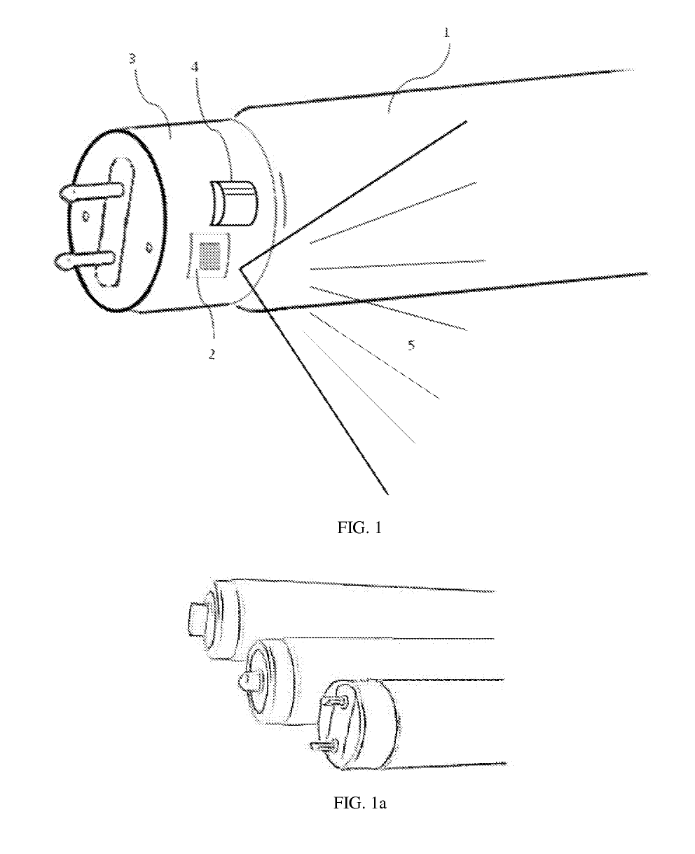

FIG. 1 shows one drawing of a fluorescent light bulb 1 with an integrated occupancy sensor and light meter 2 at the end of a long fluorescent light bulb. The hardware at one end of the light bulb has been extended toward the light tube to house the sensor and circuitry, and the glass tube light section is reduced slightly to keep the light bulb total length unchanged. Although the technology will also enable power saving of shorter light bulbs, the main purpose of this invention is to conserve the power consumption of high power (4 ft and 8 ft or longer) fluorescent light bulbs. The housing 3 could be enlarged some to accommodate the sensor and switch circuitry, as long as it can still be plugged into the original light fixture socket. A sensor lens cover 4 is used to provide a wide-angle view sensing direction 5 and to seal the unit from dust.

FIG. 1a shows one drawing of three light bulb connectors at the end of a long fluorescent light bulb. This invention can fit into any type connector and there is no limitation of which fluorescent light bulb connector. For illustration purposes, only one type of connector is used in the figures.

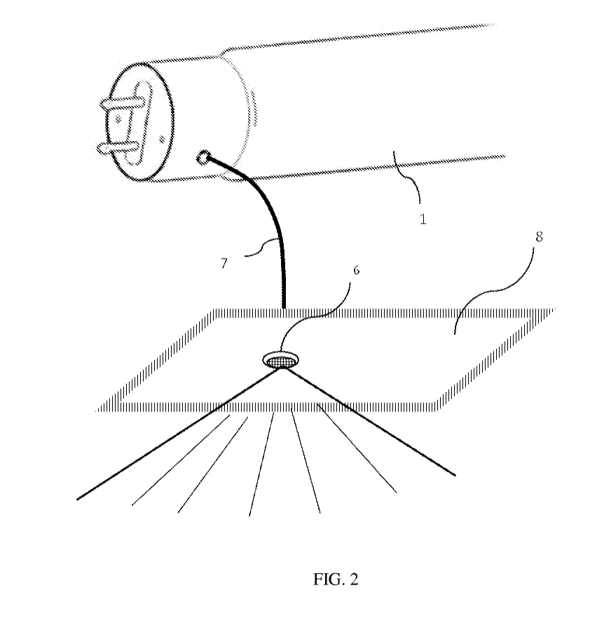

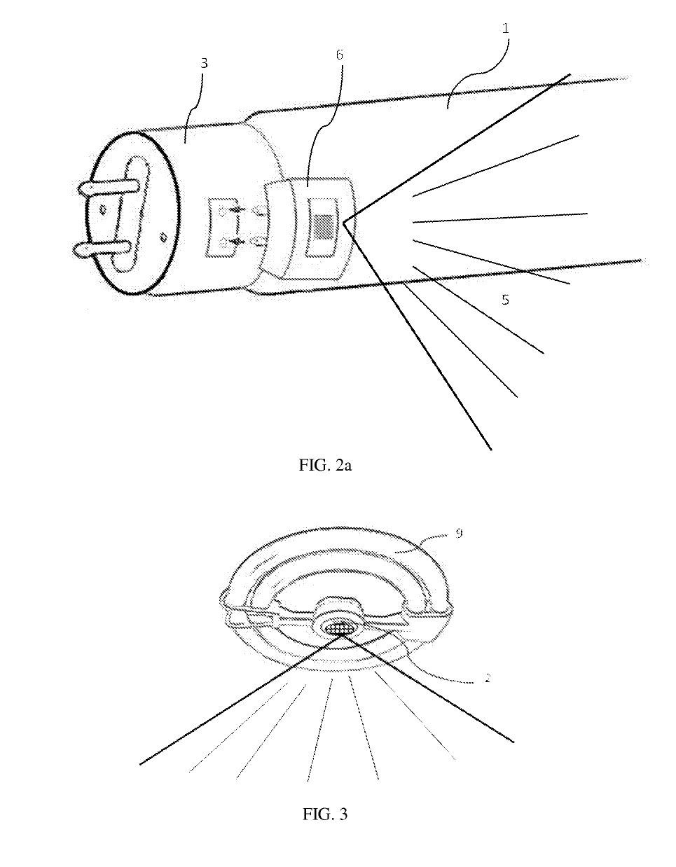

FIG. 2 shows one drawing of a light bulb with a detached occupancy sensor and light meter module 6 using a detached sensor wire 7 plugged into the end of light bulb. This would be used to improve better sensitivity when a lamp cover 8 is used in certain light fixtures.

FIG. 2a shows one drawing of a light bulb 1 with an external occupancy sensor and light meter module 6 plugged into the end of light bulb housing 3 although the shape of the module could be different. (Note: the sensor cover is not shown in the drawing.) Without the occupancy sensor plugged in, the light bulb is always on or functions the same as when it was turned on. An alternative invention is to have an occupancy sensor built into the socket but it would involve replacing the entire socket and require re-wiring, which would no longer serve its purpose of reducing the resource used due to number of light bulbs and fixtures deployed already.

FIG. 3 shows one drawing of a circular type of light bulb 9 with an integrated occupancy sensor and light meter detector 2 in the middle of a circular fluorescent light bulb 9. The hardware at the center has been enlarged to house the sensor and circuitry. A sensor lens cover is used to provide a wide angle view and to seal the unit from dust.

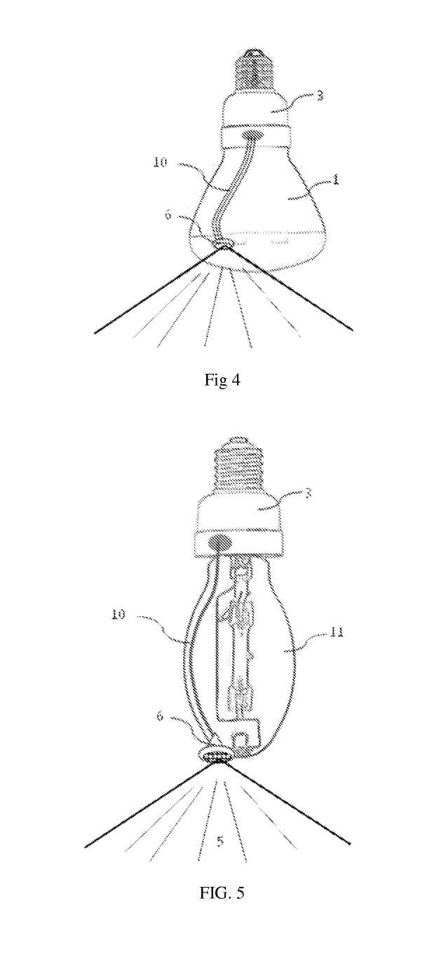

FIG. 4 shows one drawing of a light bulb with an external occupancy sensor and light meter 6 on top of a regular light bulb 1 (while the light bulb is pointing down, or at its normal mounted position). The occupancy sensor is mounted on the outer surface of the light bulb and wired to a set of on-off switches and circuitry housing 3 in the base module. The hardware at the base has been enlarged to house the on-off switch circuitry. A sensor lens cover could be used to improve the angle of view and to seal the unit from dust. The occupancy sensor and light meter unit 6 is mounted outside the bulb or extended to the outside the bulb. The link 10 between the occupancy sensor and switch circuitry could then be wired inside the bulb or routed outside the bulb as shown in the figure.

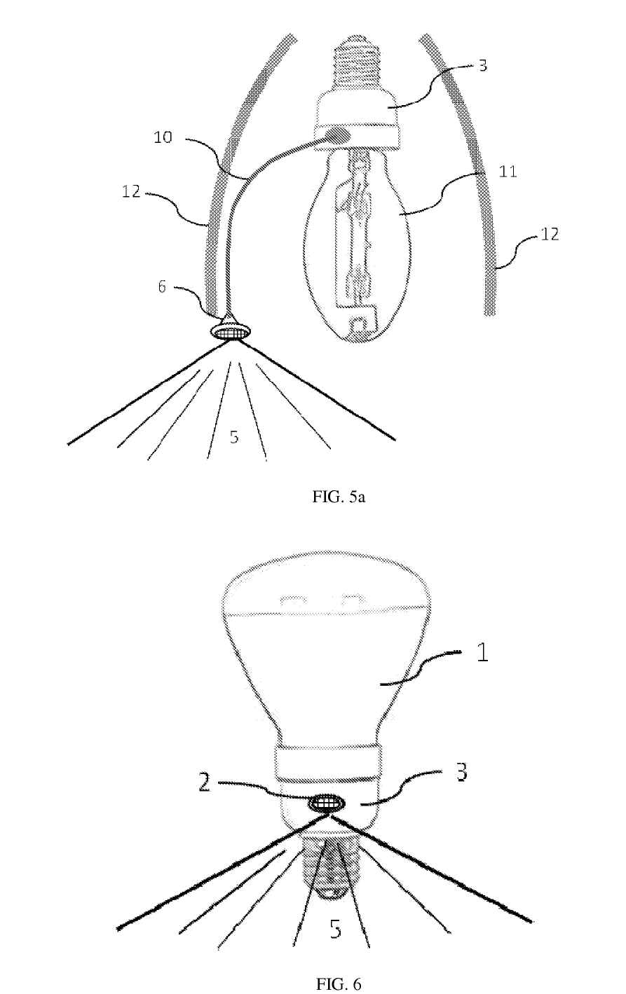

FIG. 5 shows one drawing of a metal halide (100 watt or more) light bulb 11 with an occupancy sensor and light meter 6 attached to its side. The occupancy sensor and light meter unit 6 is mounted outside of the light bulb and attached to an on-off switch with the circuitry in the base module housing 3 and sensing direction 5 points to the area needed for lighting or to where people are usually around. The hardware at the base has been enlarged to house the on-off switch circuitry and the sensing angle can be adjusted via the attaching hardware link 10. A sensor lens cover is used to improve the angle of view 5 and to seal the unit from dust.

FIG. 5a shows one drawing of a metal halide (100 watt or more) light bulb 11 with a detached occupancy sensor and light meter 6 attached to lamp shield or cover 12 and sensing direction 5 points to the area needed for lighting or to where people are usually around. The occupancy sensor is mounted or clipped to the bottom edge of the lamp cover 12 and plugged into to an on-off switch and housing 3 in the base module. The hardware at the base has been enlarged to house the on-off switch circuitry. A sensor lens cover is used to improve the angle of view and to seal the unit from dust.

FIG. 6 shows one drawing of a light bulb 1 with an integrated occupancy sensor and light meter 2 on one side of a light bulb. The occupancy sensor is mounted on the outer surface of the on-off switch and circuitry hardware housing 3 and sensing direction 5 points to the area needed for lighting or to where people are usually around. The hardware at the base has been enlarged to house the on-off switch circuitry. A sensor lens cover is used to improve the angle of view and for to seal the unit from dust.

FIG. 7 shows one drawing of a light fixture with an integrated occupancy sensor and light meter 6 on one side of the hardware. The sensing direction 5 of sensor unit is pointing to the area that needs to be lighted or to where people usually are around. The hardware at the base 13 would house the on-off switch circuitry. A sensor lens cover is used to improve the angle of view and to seal the unit from dust.

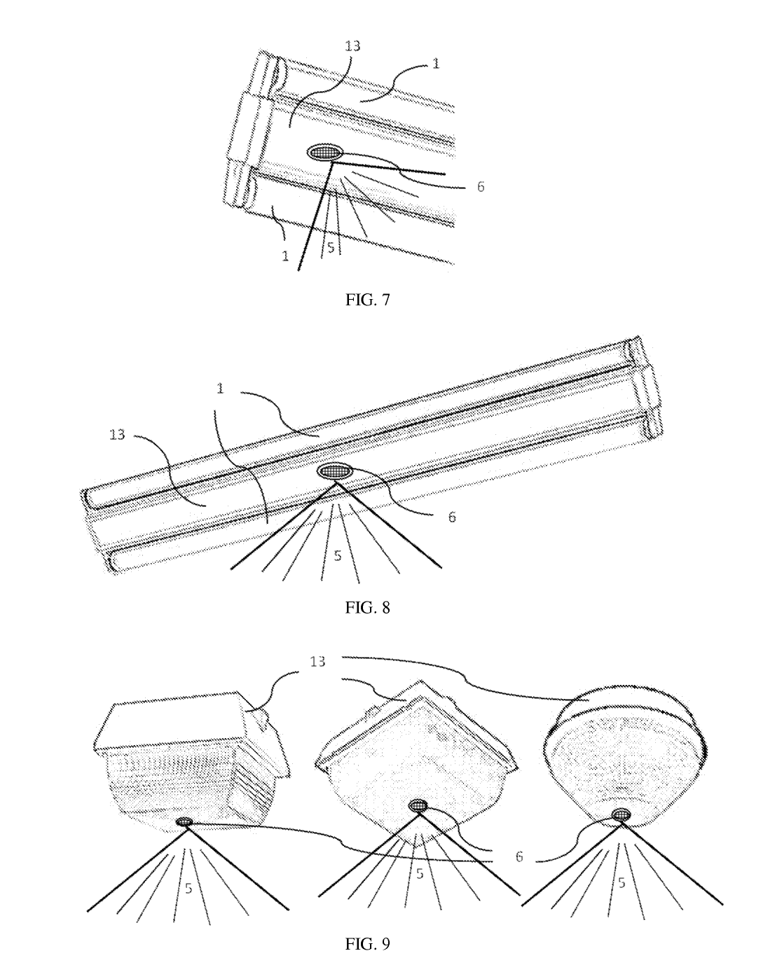

FIG. 8 shows one drawing of a light fixture with an integrated sensor unit 6 in the middle. The sensing direction 5 of sensor unit in the middle is pointing to the area that needs to be lighted or to where people usually are around. The hardware at the base 13 would house the on-off switch circuitry. A sensor lens cover is used to improve the angle of view and to seal the unit from dust.

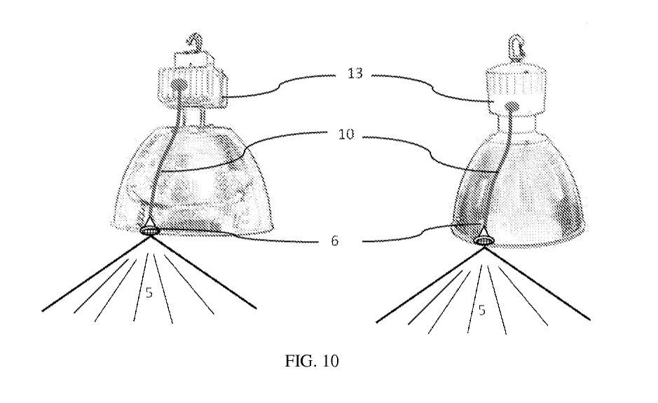

FIG. 9 shows one drawing of commercial light fixtures (high power or metal halide) with integrated occupancy and light meter 6 in the middle of the light covers. The sensing direction 5 of sensor unit in the middle is pointing to the area that needs to be lighted or to where people usually are around. The hardware at the base 13 would house the on-off switch circuitry. Note that the sensor would extend out of the light cover to achieve better sensitivity. A sensor lens cover is used to improve the angle of view and to seal the unit from dust.

FIG. 10 shows one drawing of commercial light fixtures (high power metal halide) with integrated sensor unit 6 clipped onto the lamp covers. The sensing direction 5 of sensor units is pointing to the area that needs to be lighted or to where people usually are around. The hardware at the base 13 would house the on-off switch circuitry. A sensor lens cover is used to improve the angle of view and to seal the unit from dust.

1. A method of integrating occupancy sensor, light meter, control switching, and lighting devices to conserve electricity used, said method comprising generating a signal in response to no occupancy or good lighting condition to shut off the lighting electricity use; generating a signal in response to occupancy and poor lighting condition to turn on the lighting device.

2. A lighting device comprising an integrated occupancy sensor and light meter to control switch on/off of the lighting device.

3. A lighting device comprising an external occupancy sensor and light meter to control switch on and off of the lighting device, wherein said sensor and meter unit can be plugged in to regular lighting device and re-used for different lighting device or when the lighting device is worn out. If the external sensor unit were unplugged from the lighting device, the lighting device will be functional as a traditional lighting device (light bulb or fixture).

4. A lighting device comprising an occupancy sensor, a light meter, an on/off switch, and a regulator to manage the lighting.

5. A lighting device comprising an occupancy sensor and light meter which can be adjusted and pointed to a desired lighting area for a meaningful lighting purpose.

6. The smart lighting device further comprising a software program to manage the lighting delay, operational sequence, lighting duration, reset etc, feature.

7. A lighting device occupancy sensor and light meter comprising housing for heat shield and operation purposes.

8. A fluorescent light bulb with an integrated occupancy sensor, light meter, and switch on one end.

9. A fluorescent light bulb with an external occupancy sensor, light meter, and switch on one end.

10. A circular fluorescent light bulb with an integrated occupancy sensor, light meter, and switch at the center.

11. A light bulb or a metal halide light bulb with an occupancy sensor, light meter, and on/off switch function added.

12. A light fixture with an occupancy sensor, light meter, and on/off switch function added.

13. A smart lighting device used both indoor and outdoor and adjust its lighting automatically to complement natural or artificial lighting conditions such as sun light, a skylight, window(s)', vehicle's lighting conditions.
